(19) United States
(12) Patent Application Publication
(10) Pub. No.: US 2024/0219347 A1
(43) Pub. Date: Jul. 4, 2024

(54) TWO-DIMENSIONAL MATERIAL BASED SENSOR ARRAY AND ENHANCEMENT OF ITS PERFORMANCE USING SURFACE ACOUSTIC WAVE

(71) Applicant: The George Washington University, Washington, DC (US)

(72) Inventor: Mona E. ZAGHLOUL, Bethesda, MD (US)

(21) Appl. No.: 18/228,445

(22) Filed: Jul. 31, 2023

Related U.S. Application Data
(60) Provisional application No. 63/393,630, filed on Jul. 29, 2022.

(51) Int. Cl. G01N 29/02

(52) U.S. Cl. CPC G01N 29/022; G01N 2291/021; G01N 2291/106

(57) ABSTRACT

A sensor has a surface acoustic wave (SAW) generator with an input and an output forming a SAW wave therebetween. A 2D material assembly is positioned between the input and output of the SAW generator. The 2D material assembly including a 2D material, whereby the SAW wave increases the sensitivity of the 2D material. A sensor array includes a plurality of sensors, each with a different 2D material.

### RELATED APPLICATION

This application claims the benefit of priority of U.S. Provisional Application No. 63/393,630, filed on Jul. 29, 2022, the entire content of which is relied upon and incorporated herein by reference in its entirety.

### GOVERNMENT LICENSE RIGHTS

This invention was made with government support under award number 2033044 awarded by the U.S. National Science Foundation (NSF), “Enhancement of Piezoelectric Properties in two-dimensional materials and its application.” The government has certain rights in the invention.

### BACKGROUND

Under these circumstances, a convenient, flexible, inexpensive and smart gas sensors remain in high demand. Compared with the traditional chemiresistor sensors based on the metal oxide film, the family of two-dimensional transition metal dichalcogenides (TMDCs) has attracted substantial attention because of its room temperature working condition and the demonstrations of promising physical, electronic and optical properties. See G. G. Naumis et al., “Electronic and optical properties of strained graphene and other strained 2D materials: a review,” Rep Prog Phys, vol. 80, no. 9, pp. 096501, September 2017; and O. Lopez-Sanchez et al., “Ultrasensitive photodetectors based on monolayer MoS2,” Nat Nanotechnology, vol. 8, no. 7, pp. 497-501, July 2013.

Take the gas sensing 2D material MoS2 for example, it has the advantage of high sensitivity and low concentration detection due to its high surface-to-volume ratio. See H. Li, Z. Yin, Q. He, H. Li, X. Huang, G. Lu, D. W. Fam, A. I. Tok, Q. Zhang, and H. Zhang, “Fabrication of single- and multilayer MOS2 film-based field-effect transistors for sensing no at room temperature,” Small, vol. 8, no. 1, pp. 63-67, 2011; and B. Liu, L. Chen, G. Liu, A. N. Abbas, M. Fathi, and C. Zhou, “High-performance chemical sensing using Schottky-contacted chemical vapor deposition grown monolayer MOS2 transistors,” ACS Nano, vol. 8, no. 5, pp. 5304-5314, 2014.

The mechanism of the 2D material MoS₂ based gas sensor is illustrated by Byungjin Cho which is the charge transfer between the gas molecules and the 2D material, B. Cho, M. G. Hahm, M. Choi, J. Yoon, A. R. Kim, Y.-J. Lee, S.-G. Park, J.-D. Kwon, C. S. Kim, M. Song, Y. Jeong, K.-S. Nam, S. Lee, T. J. Yoo, C. G. Kang, B. H. Lee, H. C. Ko, P. M. Ajayan, and D.-H. Kim, “Charge-transfer-based gas sensing using atomic-layer MOS2,” Scientific Reports, vol. 5, no. 1, 2015. However, only one 2D material-based gas sensor cannot identify the gas because different gases (for example, NO, NO₂, CO, NH₃. Methanol, and Acetone) can contribute to the charge transfer between the gas molecules and 2D material at the same time. Besides, one of the weaknesses of the 2D material-based gas sensors is that it takes a long time to response.

### SUMMARY

Therefore, we provide a two-dimensional material-based gas sensor array to enhance the selectivity of the 2D material-based gas sensor. In addition, we use Surface Acoustic Wave (SAW) technology to enhance the performance of such gas sensors.

### BRIEF DESCRIPTION OF THE FIGURES

The accompanying drawings are incorporated in and constitute a part of this specification. It is to be understood that the drawings illustrate only some examples of the disclosure and other examples or combinations of various examples that are not specifically illustrated in the figures may still fall within the scope of this disclosure.

Examples will now be described with additional detail through the use of the drawings, in which:

FIGS. 1(a), 1(b) show a 2D material-based gas sensor with surface acoustic wave device;

FIG. 2 shows a 2D material-based gas sensor array;

FIG. 3(a) is a 3D schematic of the MoS2 gas-sensing device;

FIG. 3(b) is a schematic of the charge density differences for MoS₂ in the presence of NO₂ gas molecules;

FIG. 4(a) is a representation of the applied perpendicular electrical field, where the arrows denote its positive direction;

FIG. 4(b) is a graph that shows a variation of charge transfer as a function of electrical field strength for NO, and NO₂ absorbed on monolayer MoS₂;

FIG. 5 shows the structure of a Surface Acoustic Wave device;

FIG. 6(a) shows the structure of SAW on LiNbO₃;

FIG. 6(b) is a simulation of the displacement of the surface of a working SAW device;

FIG. 7(a) is a graph that shows a strain tensor distribution of the SAW device;

FIG. 7(b) shows the electrical field measured at the output IDTs;

FIG. 8 is a graph of the electrical field generated at different SAW wavelength; and

FIG. 9 is a graph that shows the effect of SAW on monolayer MoS₂ based gas sensor.

### DETAILED DESCRIPTION

In describing the illustrative, non-limiting embodiments illustrated in the drawings, specific terminology will be resorted to for the sake of clarity. However, the disclosure is not intended to be limited to the specific terms so selected, and it is to be understood that each specific term includes all technical equivalents that operate in similar manner to accomplish a similar purpose. Several embodiments are described for illustrative purposes, it being understood that the description and claims are not limited to the illustrated embodiments and other embodiments not specifically shown in the drawings may also be within the scope of this disclosure.

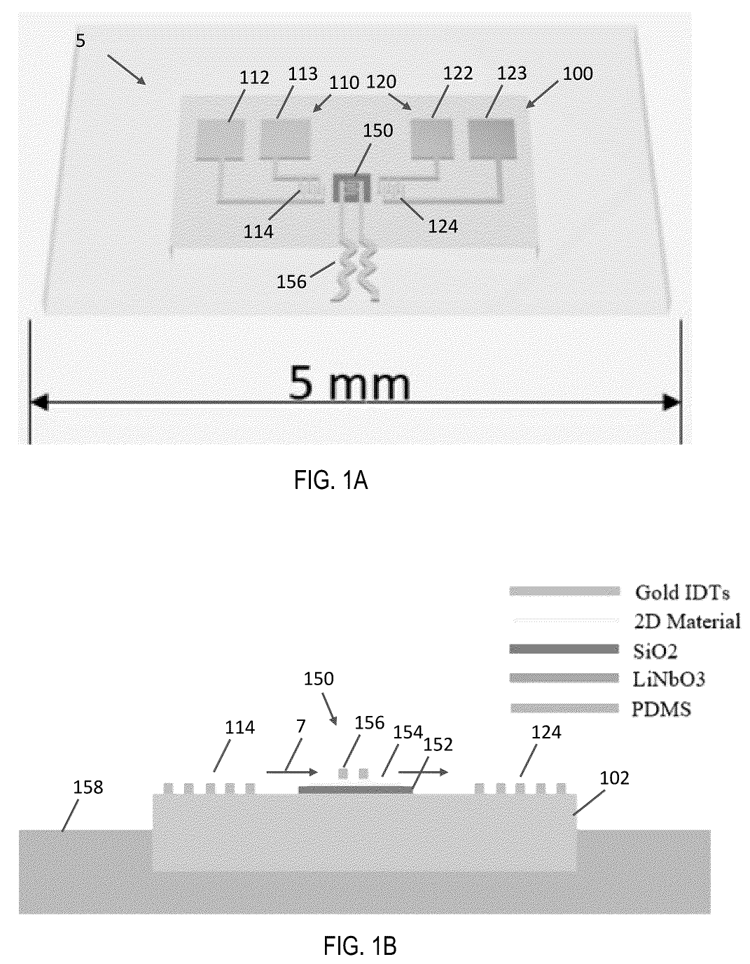

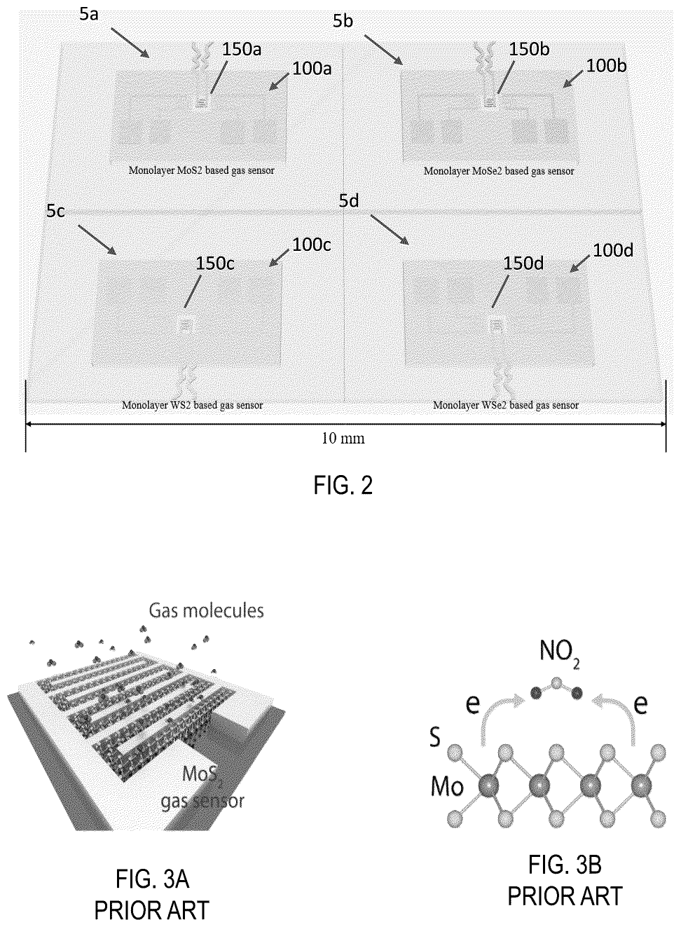

Referring to the drawings, FIGS. 1(a), 1(b) show a sensing apparatus 5 that integrates a Surface Acoustic Wave (SAW) device 100 with 2D material assembly 150 that includes a 2D material layer 154, such as for example MoS₂, MoSe₂, WS₂, and WSe₂. As shown in FIG. 2, four different gas sensor arrays 5a, 5b, 5c, 5d are shown. The electric field generated by the SAW wave is proportional to the frequency of the SAW devices 100. The electric field affects the material properties as proven in the literature, Q. Yue, Z. Shao, S. Chang, and J. Li, “Adsorption of gas molecules on monolayer MOS2 and effect of applied electric field,” Nanoscale Research Letters, vol. 8, no. 1, 2013. This approach gives the flexibility of integrating the SAW device 100 with a material 154 to change the physical properties of the materials. For example, for semiconductor material we could change the mobility, the bandgap, the conductivity and other properties using surface acoustic wave, Delsing, Per, et al. “The 2019 surface acoustic waves roadmap.” Journal of Physics D: Applied Physics 52.35 (2019): 353001.

This disclosure introduces the 2D material-based gas sensor array 5 with surface acoustic wave device 100, its preparation, and its use in detection and analysis of samples (including mixtures of NO, NO₂, CO, NH₃. Methanol, and Acetone). In one embodiment, for example, the electric field generated by the integrated SAW device 100 is controlled to increase the sensitivity of the 2D material 154, and thus the sensitivity of the gas sensor 5.

FIGS. 1(a), 1(b) show the 2D material-based gas sensor array assembly 5 with a surface acoustic wave generator 100 and 2D material assembly 150. The SAW device 100 is formed, for example, on a substrate 102 (e.g., a piezoelectric substrate), and includes an input device 110 and an output device 120. As further shown in FIG. 5, the input device 110 generates a SAW wave, and the output device 120 receives the SAW wave and converts the SAW wave to an electric signal so that the SAW wave can be measured. The input device 110 has a first input pad 112, a second input pad 113, and an input Interdigital Transducer (IDT) 114. The output device 120 has a first output pad 122, a second output pad 123, and an output IDT 124. The first input pad 112 receives a positive voltage, and the second input pad 112 is ground or a negative input voltage. The first and second input pads 112, 113 are connected to opposite ends of the input IDT 114, to generate a current through the IDT 114, which in turn generates the SAW wave. The first output pad 122 and the second output pad 123 are connected to opposite ends of the output IDT 124, and can provide a load or voltage differential.

The input IDT 114 is positioned at a first side (i.e., area) of the 2D material 150, and the output IDT 124 is positioned at a second side (i.e., area) of the 2D material 150. The first IDT 114 generates the SAW wave that travels across the 2D material 150, from the first side of the 2D material 150 to the second side of the 2D material 154. In some embodiments, the first side is opposite the second side, so that the SAW wave travels the entire length or width of the 2D material 154. The SAW wave travels across the surface of the 2D material 150. The output IDT 124 receives the SAW wave after it has traversed the 2D material 150. As the SAW wave (mechanical wave) arrives at the output IDT 124, the IDT 124 transduces the mechanical energy into electrical energy so that the SAW wave characteristics can be measured at the output pads 122, 123. Thus, the electrical signal from the output IDT 124 is received at the output IDT pads 122, 123. The output in electrical signal at the output IDT pads 122, 123 can be used to measure the SAW wave characteristics (e.g., amplitude, frequency).

As described and shown, the input 110 and output 120 each have a respective IDT 114, 124. As best shown in FIG. 5, the IDTs are metallic electrodes that each have two interlocking comb structures that face each other with fingers that alternate with each other. The input IDT 114 converts electrical signals to SAW waves, for example by generating periodically distributed mechanical forces via piezoelectric effect. The output IDT 124 converts the SAW wave back to an electrical signal. The SAW wave travels at or near the surface of the substrate 102, so it travels through (or over) the 2D material 150. Of course, other suitable electrodes and waves can be utilized other than an IDT and SAW wave, to increase the sensitivity of the 2D material 150. In still other embodiments, the waves can travel through the 2D material 150.

As best shown in FIG. 1(b), the 2D material assembly 150 has a first insulator layer 152, a second 2D material layer 154, and electrodes 156 or conducting wires. The insulator layer 152 (for example, SiO₂) is directly on and in contact with the top surface of the substrate 102, and the 2D material layer 154 is directly on and in contact with the top surface on the insulator layer 152; though in some embodiments other layers or elements can be introduced so that the insulator layer 152 does not directly contact the substrate 102 and the 2D material 154 does not directly contact the insulator layer 152.

The Interdigital Transducers (IDTs) 114, 124 (for example, gold) are fabricated on a substrate 102 (for example, LiNbO₃) to generate the surface acoustic wave. Thus, the IDTs 114, 124 are directly on and in contact with the substrate 102; though in some embodiments other layers or elements can be utilized so that the IDTs 114, 124 do not directly contact the substrate 102. The 2D material 154 (for example, MoS₂) is positioned at the middle of the substrate between the input and output IDTs 114, 124. Two electrodes 156 are attached to or fabricated on the top surface of the 2D material 154 and can be used to measure the electric wave at the 2D material 150. The SAW wave 7 causes the SAW wave to slow down or speed up. And, the SAW wave 7 affects the 2D material 150, which indicates a property of the 2D material 150. A soft PDMS 158 can be used as a protective case, and the substrate 102 can be placed on, recessed within, or partially/fully enclosed by the PDMS layer 158.

Thus, the two-dimensional (2D) material assembly has a first side and a second side. The 2D material assembly has an insulator layer with an insulator bottom surface on said substrate top surface and an insulator top surface. The 2D material assembly further has a 2D material layer with a 2D material bottom surface on the insulator top surface and a 2D material top surface. The surface acoustic wave (SAW) generator has an input InterDigital Transducer (IDT) positioned on the substrate top surface at the first side of said 2D material assembly and is configured to generate a SAW wave that travels across the 2D material layer from the first side of the 2D material assembly to the second side of the 2D material assembly. An output IDT is positioned on the substrate top surface at the second side of the 2D material assembly and configured to receive the SAW wave that traveled to the second side of the 2D material assembly. The output IDT is configured to measure characteristics of the received SAW wave. One or more electrodes 156 are coupled to the 2D material, for example at the 2D material top surface, to detect a change in property of the 2D material 150.

Further in the embodiment shown, the top surfaces of the substrate 102, insulator layer 152, 2D material layer 154 face in a first direction (upward in the embodiment shown), and the bottom surfaces of the insulator layer 152, 2D material layer 154 face in a second direction (downward in the embodiment shown) that is opposite the first direction. Accordingly, the top and bottom surfaces of the substrate 102, insulator layer 152, 2D material layer 154 are substantially planar and linear, and are parallel with one another and come into direct contact. However, in other embodiments, the surfaces need not be linear and planar or parallel to one another, and need not come into direct contact.

The input IDT 114 and output IDT 124 convert electric signals to a SAW wave 7 (FIGS. 1(b), 5) that travels from the input IDT 114 to the output IDT 124, through the 2D material 154. The electrodes 156 measure the voltage (i.e., change in conductivity) at the 2D material 154, to detect the electrical change due to the 2D material. The electrodes 156 can be connected, for example, to a voltage detector or oscilloscope to determine the change in properties at the 2D material 154. The SAW wave 7 changes the properties of the 2D material 154, which can be utilized for a number of applications such as for a sensor. For example, SAW waves can be used to change the inner properties of the 2D material to have a higher conductivity. It can also be utilized to select material for various applications, such as resistors. The SAW wave 7 provides high conductivity of the 2D material 154 by applying a compression/decompression action to the 2D material 154. The change in sensitivity, as well as the frequency, electric field, can vary depending on the specific application to be made of the sensor 5.

FIG. 2 shows four gas sensor array assemblies 5, where each gas sensor assembly 5 similar to the embodiment of FIGS. 1(a), 1(b). Each gas sensor 10 has a respective monolayer 2D material 150 that differs from the other gas sensors 10. For example, the first gas sensor 5a can have a first 2D material 150a (for example, MoS₂) and a first SAW wave device 100a that generates a first SAW wave; a second gas sensor 5b can have a second 2D material 150b (for example, MoSe₂) and a second SAW wave device 100b that generates a second SAW wave; a third gas sensor 5c can have a third 2D material 150c (for example, WS₂) and a third SAW wave device 100c that generates a second SAW wave; and a fourth gas sensor 5d can have a fourth 2D material 150d (for example, WSe₂) and a fourth SAW wave device 100a that generates a fourth SAW wave. The first, second, third, and fourth SAW waves can be the same or different. In other embodiments, the 2D materials 150a, 150b, 150c, 150d can be the same in some or all of the 2D material, with the same or different SAW waves. The different materials 150a, 150b, 150c, 150d have different structures, such as band gap structure and molecular sizes, and therefore have a different response to the SAW wave.

The gas sensors 5 are fabricated and can optionally be contained within a housing or structure (e.g., a sensor housing) that completely or partially encloses the sensor 5. The gas sensors 5a-5d can be coupled to the substrate and/or structure. As mixed gases flow through this gas sensor array 10, each gas sensor 5 will respond differently. The response is a measured current when applying the same voltage. The response difference is caused by the different charge transfer between the gas molecules and the 2D material of gas sensors. The SAW wave enhances the sensing of the 2D material. The SAW wave devices 150 each generate an electric field which enhances sensitivity of the 2D material, so you can detect very small molecules (very sensitive), because you have electric field in addition to an acoustic wave.

In the example embodiment of FIG. 2, the array 10 has the following features: (1) a size smaller than 10 mm×10 mm; (2) a gas sensor array 10 of 4 gas sensors 5; (3) each gas sensor 5 is composed of a SAW device 150a-150c and a 2D material 150 (MoS₂, MoSe₂, WS₂, and WSe₂) based gas sensor; (4) the surface acoustic wave device can propagate with electrical field and strain field; (5) the electrical field and strain field that generated by SAW can change the mobility, the bandgap, the conductivity and other properties of the 2D materials; (6) the electrical field can enhance the sensitivity of the 2D material based gas sensor; (7) the gas sensors 5a-5d can detect different gases with low concentration (down to 1 ppm); (8) the gas sensor 5 can be operated at different temperatures; (9) the gas sensor 5 is a light, flexible, low cost, and stable device; (10) the gas sensor 5 is very easy to operate.

### Working Mechanism:

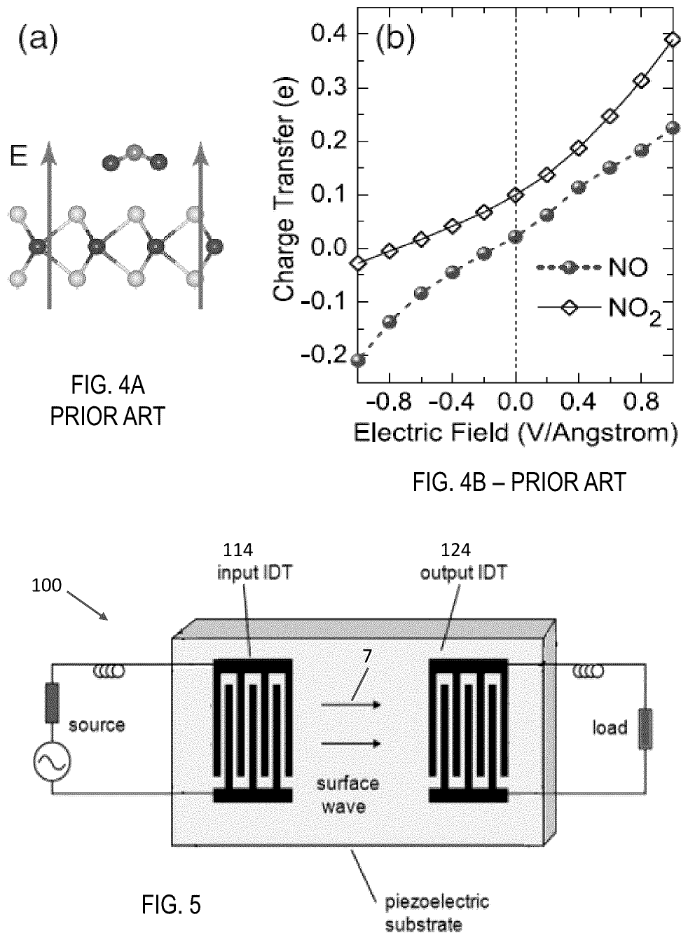

The mechanism of the 2D material MoS₂ gas sensor can be any suitable technique, such as the one illustrated by Byungjin Cho for the charge transfer between the gas molecules and the 2D material, B. Cho, M. G. Hahm, M. Choi, J. Yoon, A. R. Kim, Y.-J. Lee, S.-G. Park, J.-D. Kwon, C. S. Kim, M. Song, Y. Jeong, K.-S. Nam, S. Lee, T. J. Yoo, C. G. Kang, B. H. Lee, H. C. Ko, P. M. Ajayan, and D.-H. Kim, “Charge-transfer-based gas sensing using atomic-layer MOS2,” Scientific Reports, vol. 5, no. 1, 2015. FIG. 3(a) is a 3D schematic of the MoS₂ gas-sensing device while FIG. 3(b) shows the schematic of the charge density differences for MoS₂ in the presence of NO₂ gas molecules. FIGS. 3(a), 3(b) are from the B. Cho paper. The NO₂ acts as an electron acceptor, resulting in p-doping. The NO₂ molecules on the surface of MoS₂ bring the Fermi level closer to the valence-band edge. The electrodes 156 on the 2D material are used to measure the properties change of the 2D material when it is affected by both SAW and gas molecule. As a gas sensor, the electrodes 156 on the 2D material 150 are used to measure the I-V (current and voltage) characteristic when the sensor is exposed to above gas. The electric field measured by the output 120 is then used to determine the gas that is detected, such as illustrated by FIG. 4(b).

Most of the gas molecules (H₂, O₂, H₂O, NO, NO₂, and CO) are weakly adsorbed on the monolayer MoS₂ surface and acts as charge accepters, while the NH₃ molecules are adsorbed as charge donors. This weak absorption or the charge transfer between the absorbed molecule and 2D MoS2 can significantly be enhanced by a perpendicular electrical field, Q. Yue, Z. Shao, S. Chang, and J. Li, “Adsorption of gas molecules on monolayer MOS2 and effect of applied electric field,” Nanoscale Research Letters, vol. 8, no. 1, 2013. As demonstrated by Qu Yue et al in FIG. 4, the charge transfer between the gas molecules and 2D material is affected by the external electrical field. FIGS. 4(a), 4(b) are from the Q. Yue paper.

The surface acoustic wave will propagate the electrical field so that the charge transfer rate can be enhanced by surface acoustic wave. One example embodiment of the SAW device 100 structure is shown in FIG. 5. The Interdigital Transducers (IDTs) 110, 120 are made of metal, the substrate 102 is piezoelectric material. In FIG. 5, an AC source is applied between the electrodes on the input IDT 114, and the voltage on the load of the output is read.

The SAW travels on the piezoelectric surface with electric field and strain field. See P. Delsing, A. N. Cleland, M. J. Schuetz, J. Knörzer, G. Giedke, J. I. Cirac, K. Srinivasan, M. Wu, K. C. Balram, C. Bauerle, T. Meunier, C. J. Ford, P. V. Santos, E. Cerda-Mendez, H. Wang, H. J. Krenner, E. D. Nysten, M. Weiβ, G. R. Nash, L. Thevenard, C. Gourdon, P. Rovillain, M. Marangolo, J.-Y. Duquesne, G. Fischerauer, W. Ruile, A. Reiner, B. Paschke, D. Denysenko, D. Volkmer, A. Wixforth, H. Bruus, M. Wiklund, J. Reboud, J. M. Cooper, Y. Q. Fu, M. S. Brugger, F. Rehfeldt, and C. Westerhausen, “The 2019 surface acoustic waves roadmap,” Journal of Physics D: Applied Physics, vol. 52, no. 35, p. 353001, 2019; B. Dong, A. Afanasev, R. Johnson, and M. Zaghloul, “Enhancement of photoemission on P-type GaAs using surface acoustic waves,” Sensors, vol. 20, no. 8, p. 2419, 2020; B. Dong and M. E. Zaghloul, “Generation and enhancement of surface acoustic waves on a highly doped p-type GaAs substrate,” Nanoscale Advances, vol. 1, no. 9, pp. 3537-3546, 2019; and A. N. Darinskii, M. Weihnacht, and H. Schmidt, “Surface acoustic wave electric field effect on acoustic streaming: Numerical Analysis,” Journal of Applied Physics, vol. 123, no. 1, p. 014902, 2018.

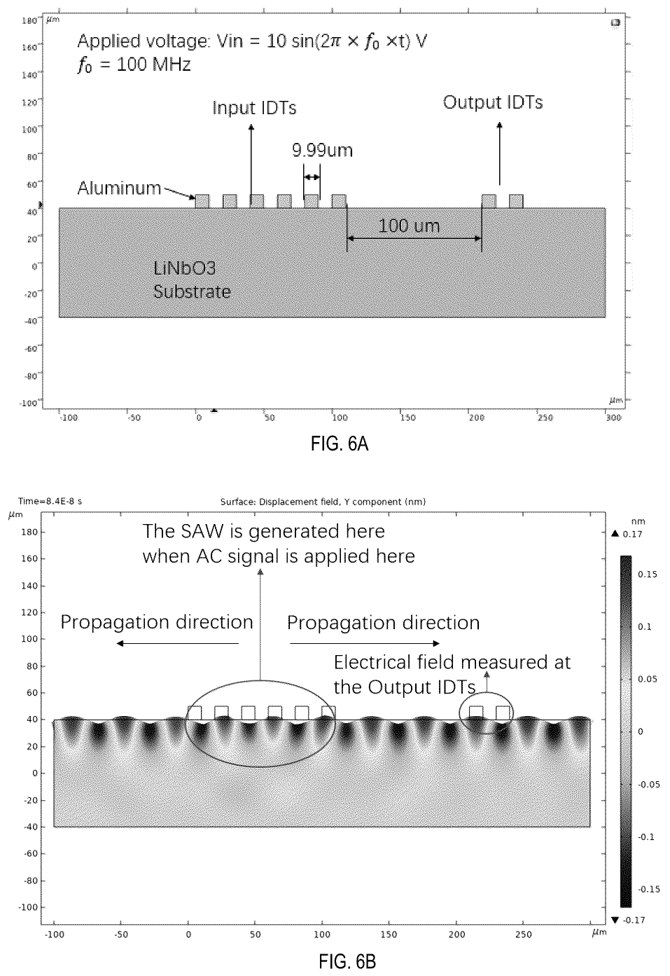

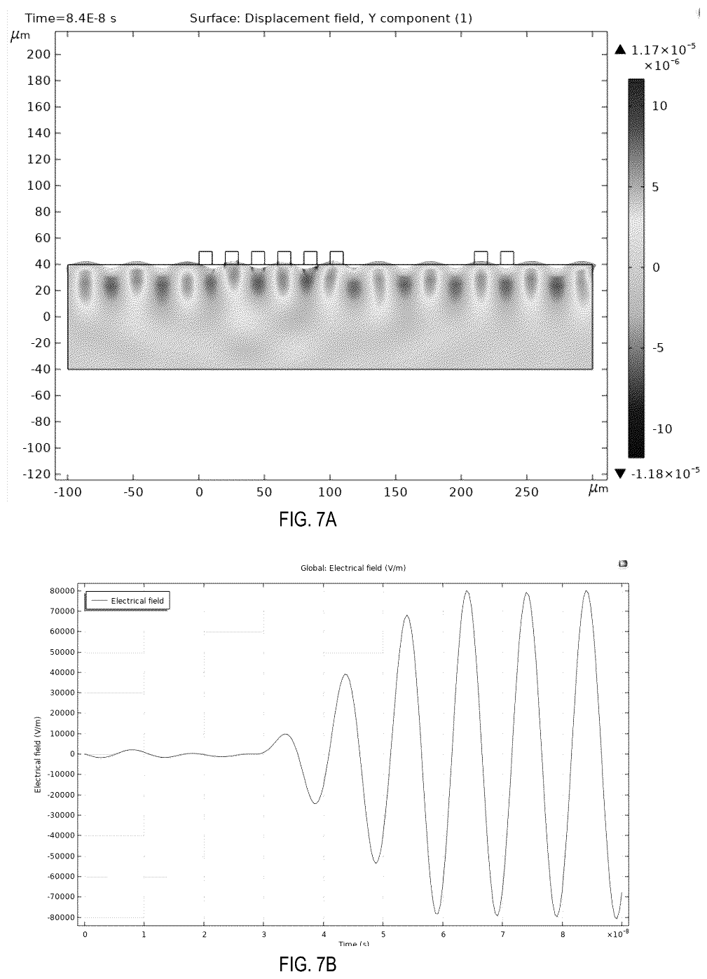

FIGS. 6(a), 6(b) show the simulation of a SAW device 100. The input IDT 114 can be separated from the output IDT 124 by a distance of approximately 100 μm. When the simulation starts, a displacement along the Y axis can be observed. After the SAW is generated, it propagates from the center of input IDT 114 towards both ends of the piezoelectric substrate LiNbO₃. In this simulation, a 100 MHz SAW device simulation is demonstrated. The LiNbO₃ is used for the piezoelectric substrate 102 while Aluminum is used for 3 pairs of input IDTs and one pair of output IDTs, which depend on the number of fingers in the IDT structure. The AC voltage (Vin) that applied on the input pad 112 of the input IDT 114 is: Vin=10 sin(2π×f₀×t) V, where f₀ is the working frequency and t is the time.

Thus, the SAW wave is a sine wave that has compression and decompression. The downward portions (blue) shows large displacement (compression/decompression), and the upward portions (red and yellow) show smaller displacement.

FIG. 7(a) shows the strain tensor along Y axis and electrical field measured between the output IDTs 124. We can see that the SAW propagates with strain field and electrical field. The phase and amplitude of the electrical field between the electrodes of the output IDTs are measured and shown in FIG. 7(b). The curve of the electrical field vs. time become stable after 60 ns since the start of the SAW device.

In addition to the SAW acoustic wave, the apparatus can measure the electric field between the two electrodes 156. The SAW causes particles of the 2D materials (which have a crystal structure) to shake (compress/decompress), which creates a particle charge, which generates the electric field that is measured by the electrodes.

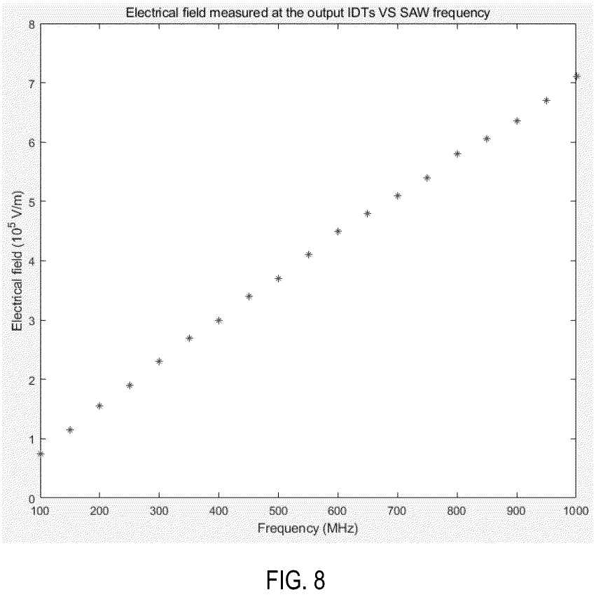

From the simulation results of the electrical field generated by SAW device, we can find that when the working frequency increases (or the wavelength decreases), the time needed for the electrical field to be stable becomes shorter. We also see that when the frequency increases, the amplitude of the electrical field increases linearly. FIG. 8 plots the electrical field VS the wavelength of the SAW device.

From the results, we know that the phase and amplitude of the electrical field can be effectively influenced by the SAW working frequency. If we want the signal received at the output IDTs to be stable faster, a SAW device with high frequency and short wavelength is required. If we want a high electrical field generated by SAW, we need to design a short wavelength SAW device.

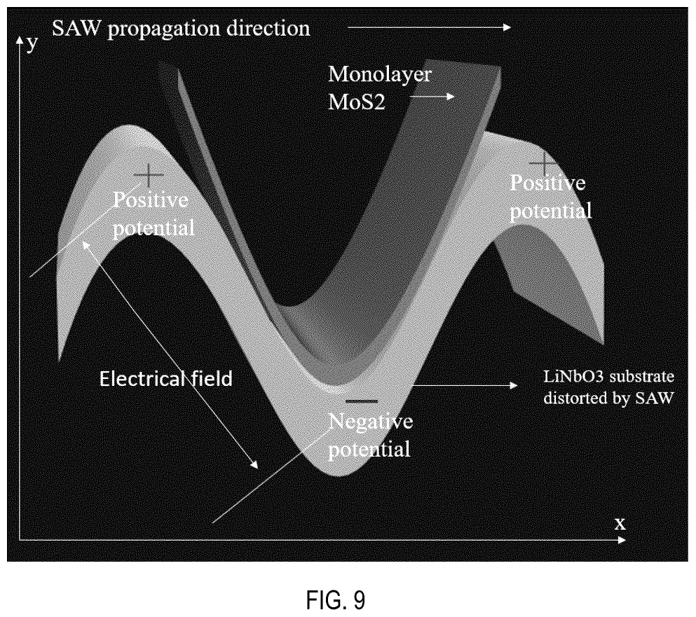

The effect that the SAW will apply on the MoS₂ is shown in FIG. 9. As the SAW propagates along the surface of piezoelectric material, the electrical field generated from the SAW will enhance the charge transfer between gas molecules and 2D material-based gas sensor. The 2D material changes to takes on the sine wave pattern of the SAW wave. It is noted that in the embodiments shown and described, the substrate 102, insulator layer 152, 2D material 154 has a linear or planar flat top and/or bottom surface. However, those surfaces need not be linear, but can be curved or any other suitable shape. In addition, the insulator layer 152 and 2D material are shown to be relatively thin, such that the thickness is much smaller than the length and/or width. However, other suitable embodiments can be provided within the spirit and scope of the disclosure.

It is further noted that the sensor 5 has been shown and described for use with 2D materials. The 2D material have top and bottom surfaces formed in the x- and y-directions (length and width), and a thickness formed in the z-direction, but the thickness is very small so that the 2D material is very thin. However, other suitable applications can be utilized, such as for materials that are not two-dimensional, but can include, for example, a number of layers that form a three-dimensional material yet are at least partially responsive to a SAW wave or other wave, such as to increase sensitivity, and can form a sensor.

In addition, the sensor 5 has been shown and described to have particular use to detect a gas. However, it can be used for any application, for example, to detect a fluid (i.e., gas or liquid) or other substance or material. It is further noted that a computer, controller or other processing device can be utilized to determine the detected substance. For example, the processor can receive the electrical characteristics (voltage, current, etc.) detected at the electrodes 156 or output 110, analyze that information to determine or determine the substance that is detected. Such processing device can be integrated with the sensor 5, such as within a common housing, and receive the signals directly through wire. Or the processing device can be located remotely and in wireless communication with the sensor 5, which can be provided with a wireless communication device to communicate with the processing device.

It is noted that the drawings may illustrate, and the description and claims may use geometric or relational terms, such as top, bottom, opposite, direct, upward, downward, direction, side, contact, planar, layer, flat, surface, linear, planar, thin, smaller, etc. These terms are not intended to limit the disclosure and, in general, are used for convenience to facilitate the description based on the examples shown in the figures. In addition, the geometric or relational terms may not be exact because of, for example, roughness of surfaces, tolerances allowed in manufacturing, etc.

It will be apparent to those skilled in the art having the benefit of the teachings presented in the foregoing descriptions and the associated drawings that modifications, combinations, sub-combinations, and variations can be made without departing from the spirit or scope of this disclosure. Likewise, the various examples described may be used individually or in combination with other examples. Those skilled in the art will appreciate various combinations of examples not specifically described or illustrated herein that are still within the scope of this disclosure. In this respect, it is to be understood that the disclosure is not limited to the specific examples set forth and the examples of the disclosure are intended to be illustrative, not limiting.

1. A sensor comprising:
a surface acoustic wave (SAW) generator having an input and an output and a SAW wave therebetween; and
a material assembly positioned between the input and output of the SAW generator, said material assembly including a material, whereby the SAW wave changes properties of the material.

2. The sensor of claim 1, wherein the output measures a change in the SAW wave and indicates a property of a target substance.

3. The sensor of claim 1, wherein the SAW enhances the sensitivity of the material.

4. The sensor of claim 1, wherein the SAW enhances sensitivity of the material to detect very small molecules.

5. The sensor of claim 1, wherein the SAW generates an electric field at the material.

6. The sensor of claim 1, the input of said SAW generator comprises an input InterDigital Transducer (IDT).

7. The sensor of claim 1, the output of said SAW generator comprises an output InterDigital Transducer (IDT).

8. The sensor of claim 1, wherein the SAW wave travels across the material.

9. The sensor of claim 1, further comprising one or more electrodes coupled to said material to detect a property change of said material.

10. The sensor of claim 9, wherein the property change is in response to the material contacting a target substance.

11. The sensor of claim 10, wherein the target substance is a fluid.

12. The sensor of claim 11, wherein the fluid is a gas or liquid.

13. The sensor of claim 1, wherein the material comprises a two-dimensional (2D) material.

14. A sensor array, comprising:
a plurality of sensors, each sensor including:
a surface acoustic wave (SAW) generator having an input and an output and a SAW wave therebetween; and
a two-dimensional (2D) material assembly positioned between the input and output of the SAW generator, said material assembly including a 2D material, whereby the SAW wave changes properties of the material, and wherein said 2D material differs for each of the respective plurality of sensors.

15. A gas sensor comprising:
a substrate having a substrate top surface;
a two-dimensional (2D) material assembly having a first side and a second side, said 2D material assembly having an insulator layer with an insulator bottom surface on said substrate top surface and an insulator top surface, said 2D material assembly further having a 2D material layer with a 2D material bottom surface on said insulator top surface and a 2D material top surface; and
a surface acoustic wave (SAW) generator comprising:
an input InterDigital Transducer (IDT) positioned on said substrate top surface at the first side of said 2D material assembly and configured to generate a SAW wave that travels across said 2D material layer from the first side of said 2D material assembly to the second side of said 2D material assembly;
an output IDT positioned on said substrate top surface at the second side of said 2D material assembly and configured to receive the SAW wave that traveled to the second side of said 2D material assembly, said output IDT configured to measure characteristics of the received SAW wave; and
one or more electrodes coupled to said 2D material to detect a change in property of said 2D material.

16. The gas sensor of claim 15, wherein said one or more electrodes are coupled to said 2D material top surface.
